(19) United States
(12) Patent Application Publication
(10) Pub. No.: US 2004/0103163 A1
(43) Pub. Date: May 27, 2004

(54) Serial bus disk extender and portable storage device

(76) Inventors: Hao-Hsing Lin, Taipei Hsien (TW); Jiun-Rung Fang, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,903

(22) Filed: Nov. 27, 2002

(51) Int. Cl. G06F 15/16

(52) U.S. Cl. 709/211; 709/253

(57) ABSTRACT

A portable storage device connects to a master computer and a first slave computer through a serial bus interface. The portable storage device contains a non-volatile memory for storing data in the portable storage device, a first slave port for connecting the portable storage device to the first slave computer through the serial bus interface, and a master port for connecting the portable storage device to the master computer through the serial bus interface. The master computer can access data located on the portable storage device and storage apparatuses of the first slave computer and the first slave computer cannot access any data located on the portable storage device and the master computer.

### BACKGROUND OF INVENTION

1. Field of the Invention

The present invention relates to a portable storage device with a serial bus interface, and more specifically, to a portable storage device capable of providing a master computer with access to files on a slave computer.

2. Description of the Prior Art

Recently, peripheral devices that connect to personal computers (PCs) through serial buses have risen in popularity. Currently, the two most popular serial bus standards are the universal serial bus (USB) and the Institute of Electrical and Electronic Engineers (IEEE) 1394 interfaces. One popular device is a portable storage device with a serial bus interface that can be used to easily transfer large amounts of data from one computer to another. On the current marketplace, USB devices are more widespread than their IEEE 1394 counterparts, and for simplicity the following description will refer only to USB devices.

Please refer to FIG. 1. FIG. 1 is a block diagram of a portable storage device 10 with a USB interface according to the prior art. The portable storage device 10 connects to a PC 20 through a port 12. The port 12 is typically a male USB connector that connects to a female USB connector on the PC 20, although a cable could also be used to connect the portable storage device 10 to the PC 20. The port 12 is electrically connected to an application specific integrated circuit (ASIC) 14 that is used to control the basic operating functions of the portable storage device 10. The ASIC 14 is electrically connected to embedded storage 16, which is typically a flash memory used for storing data. In addition, the ASIC 14 can also be connected to an optional expansion slot 18. The expansion slot 18 can be used for inserting a memory card into the portable storage device 10. Once the portable storage device 10 is connected to the PC 20, the PC 20 can then access data stored on both the embedded storage 16 and the memory card in the expansion slot 18. The prior art portable storage device 10 can connect to the PC 20 through either the USB standard or through the USB On-The-Go (USB OTG) standard. As the structure and operation of the portable storage device 10 shown in FIG. 1 is well known in the art, it will not be described in greater detail.

Please refer to FIG. 2. FIG. 2 is a block diagram of a network linker 30 according to the prior art. The network linker 30 connects to a first PC 36 through a first port 32 and connects to a second PC 38 through a second port 34. Both the first port 32 and the second port 34 respectively connect to the first PC 36 and the second PC 38 through USB cables. The network linker 30 is used to provide a network connection between the first PC 36 and the second PC 38 through a USB interface. More specifically, the network linker 32 functions as a two-way communication device that can allow PCs 36 and 38 to communicate with each other and transfer data in either direction.

Currently, there are no products on the marketplace that allow a portable storage device to connect a master PC to a slave PC, such that the master PC can access data on both the portable storage device and the slave PC, while at the same time preventing the slave PC from accessing data on either the portable storage device or the master PC.

### SUMMARY OF INVENTION

It is therefore a primary objective of the claimed invention to provide a portable storage device for connecting a master computer to a slave computer in order to solve the above-mentioned problems.

According to the claimed invention, a portable storage device connects to a master computer and a first slave computer through a serial bus interface. The portable storage device contains a non-volatile memory for storing data in the portable storage device, a first slave port for connecting the portable storage device to the first slave computer through the serial bus interface, and a master port for connecting the portable storage device to the master computer through the serial bus interface. The master computer can access data located on the portable storage device and storage apparatuses of the first slave computer and the first slave computer cannot access any data located on the portable storage device and the master computer.

It is an advantage of the claimed invention that the portable storage device allows the master computer to instantly extend its storage capabilities by accessing the data on both the portable storage device and the slave computer without giving the slave computer access to the data on the master computer.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of a portable storage device according to the prior art.

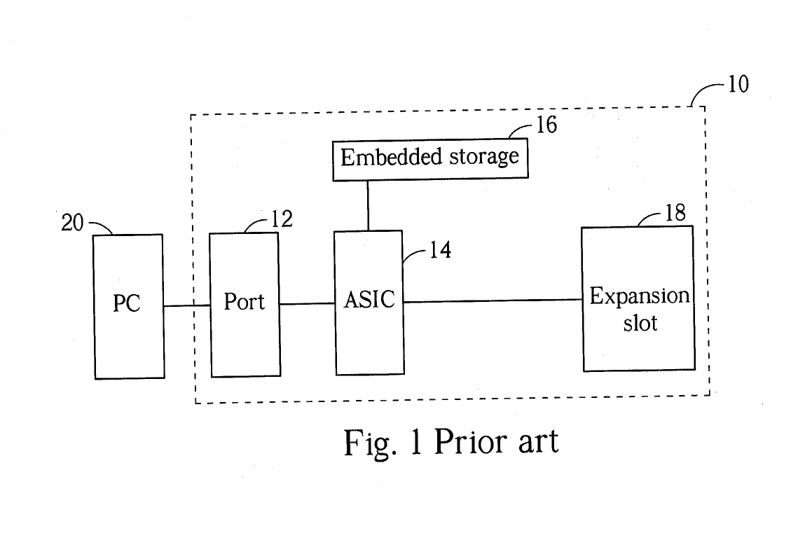

FIG. 2 is a block diagram of a network linker according to the prior art.

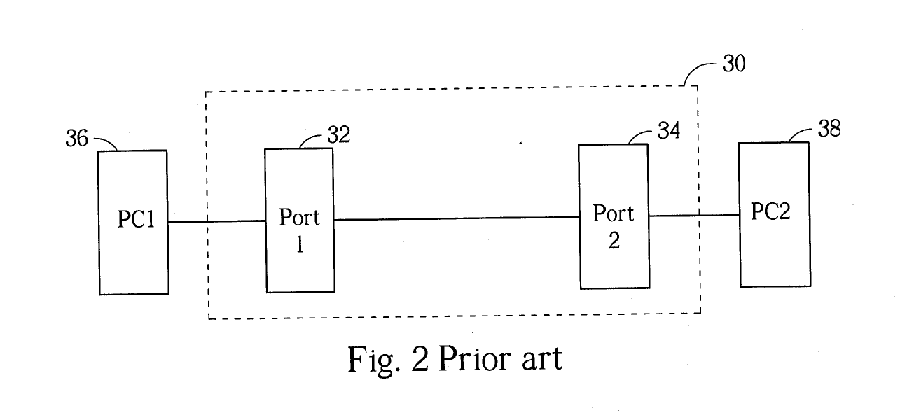

FIG. 3 is a block diagram of a disk extender according to a first embodiment of the present invention.

FIG. 4 is a diagram of software architecture of the disk extender, a master PC, and a slave PC according to the present invention.

FIG. 5 is a flowchart illustrating the master PC reading data through the disk extender.

FIG. 6 is a flowchart illustrating the master PC writing data through the use of the disk extender.

FIG. 7 is a block diagram of a disk extender according to a second embodiment of the present invention.

### DETAILED DESCRIPTION

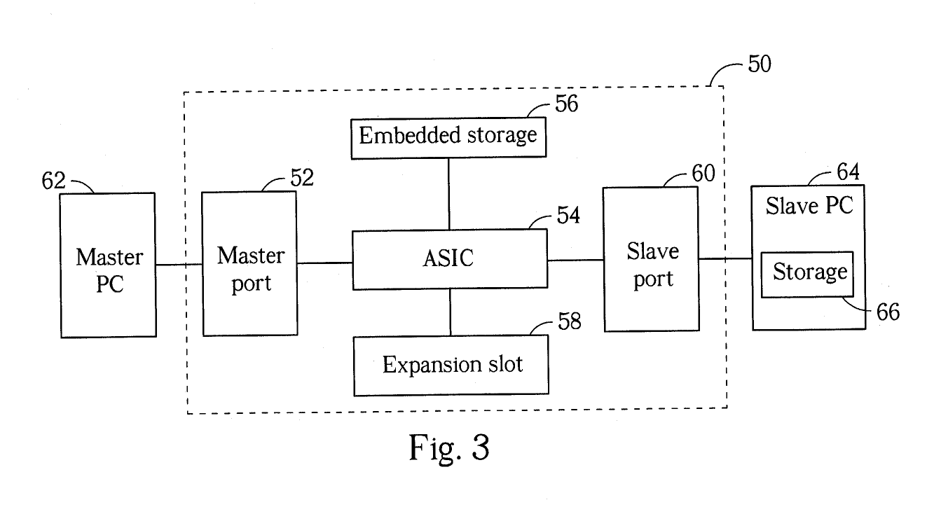

Please refer to FIG. 3. FIG. 3 is a block diagram of a disk extender 50 according to a first embodiment of the present invention. The disk extender 50 connects to a master PC 62 and a slave PC 64 through a master port 52 and a slave port 60, respectively. The master port 52 is preferably a male USB connector that connects to a female USB connector on the master PC 62, although a cable could also be used to connect the master port 52 to the master PC 62. The slave port 60 preferably connects to the slave PC 64 through a cable.

The master port 52 and the slave port 60 are each electrically connected to an ASIC 54, which is used to control basic operations of the disk extender 50. The ASIC 54 is electrically connected to embedded storage 56, which is preferably programmable non-volatile memory such as flash memory. In addition, the ASIC 54 can also be connected to an expansion slot 58. The expansion slot 58 can be used for inserting a memory card into the disk extender 50 or for connecting external storage devices to the disk extender 50. The external devices may be IDE or ATA/ATAPI devices, and can provide additional storage capacity to the disk extender 50.

The slave PC 64 includes at least one storage device 66 that is connected to the slave PC 64 such as an internal or external hard drive, an internal or external CD-ROM drive, a floppy disk drive, memory card reader, shared drives over a network, and so on. The main advantage of the present invention is that once the master PC 62 and the slave PC 64 are connected to the disk extender 50, the master PC 62 is able to access data of the embedded storage 56 of the disk extender 50 and the storage device 66 of the slave PC 64. If the expansion device were used, the master PC 62 would also have access to the device connected to the expansion slot 58 of the disk extender 50. On the other hand, the slave PC 64 cannot access any data stored on the master PC 62, the embedded storage 56, or any external device connected to the disk extender 50 through the expansion slot 58. In effect, this configuration allows the master PC 62 to extend its storage capacity by using the storage provided by the disk extender 50 and the slave PC 64 without revealing any of the data on the master PC 62 to the slave PC 64.

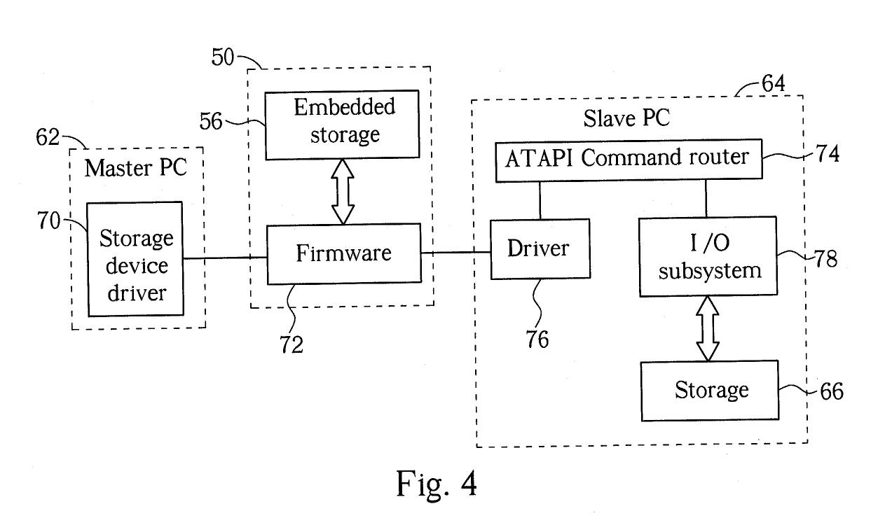

Please refer to FIG. 4. FIG. 4 is a diagram of software architecture of the disk extender 50, the master PC 62, and the slave PC 64 according to the present invention. The master PC 62 has a USB storage device driver 70 that allows the master PC 62 to communicate with the disk extender 50. If the master PC 62 contains a relatively new operating system, such as a version of Windows later than Windows 98, the master PC 62 can use a built-in driver from the operating system to supply the storage device driver 70. Thus, for newer operating systems, no driver has to be installed onto the master PC 62 by a user of the disk extender 50. For interfacing with the master PC 62 and the slave PC 64, the disk extender 50 is equipped with firmware 72.

When the slave PC 64 is connected to the disk extender 50, a driver 76 and an Advanced Technology Attachment Packet Interface (ATAPI) command router 74 are installed on the slave PC 64. The slave PC 64 is then able to communicate with the firmware 72 of the disk extender 50 through the driver 76, such as a Windows Model Driver (WDM). The driver 76 and the firmware 72 are each compatible with the USB Mass Storage Class Bulk-Only Transport specification, and send and receive data according to this specification. The ATAPI command router 74 serves as an interface to an I/O subsystem 78 of the slave PC 64. The ATAPI command router 74 is in charge of issuing ATAPI command packets and transferring data between the I/O subsystem 78 and the disk extender 50 to enable data transfer between the slave PC 64 and the disk extender 50. The I/O subsystem 78 communicates with each storage device 66 connected to the slave PC 64.

After the master PC 62 is connected to the disk extender 50, the master PC 62 treats the disk extender 50 as a slave device. Likewise, after the slave PC 64 is connected to the disk extender 50, the disk extender 50 treats the slave PC 64 as a slave device. Through the driver 76 installed on the slave PC 64, the disk extender 50 is able to map out each storage device 66 connected to the slave PC 64 and map each storage device 66 as remote USB storage devices on the master PC 62. Each storage device 66 is assigned a logical unit number (LUN), ranging from X to X+N−1, where X is the number of storage devices on the disk extender 50 and N is the number of storage devices 66 on the slave PC 64. Furthermore, the embedded storage 56 and any external storage device connected to the disk extender 50 through the expansion slot 58 are also mapped as remote USB storage devices on the master PC 62. These devices would be assigned a LUN ranging from 0 to X−1, where X is the total number of storage devices on the disk extender 50, including the embedded storage 56. Once the LUNs are assigned, the master PC 62 is able to read data from or write data to the embedded storage 56, an external storage device connected through the expansion slot 58, or any storage device 66.

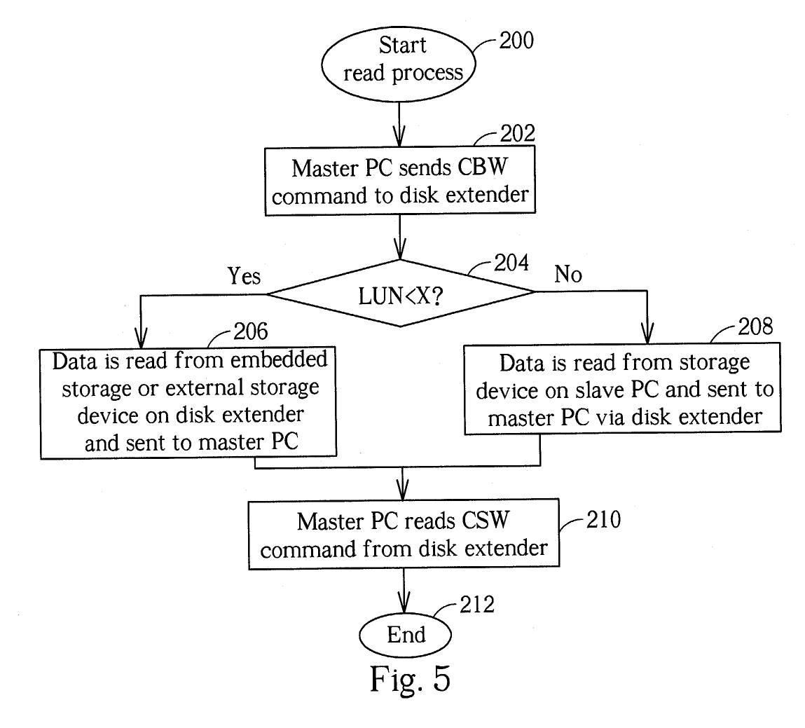

Please refer to FIG. 5. FIG. 5 is a flowchart illustrating the master PC 62 reading data through the disk extender 50.

Step 200:

The read process is started to allow the master PC 62 to read data from either the embedded storage 56 in the disk extender 50 or from the storage device 66 in the slave PC 64;

Step 202:

The master PC 62 sends a Command Block Wrapper (CBW) command to the disk extender 50 (the CBW command is an ATAPI command specifying the LUN of the device to be read from and the amount of data to be read);

Step 204:

Determine if the LUN contained in the CBW command is less than X; if so, go to step 206; if not, go to step 208;

Step 206:

Since the LUN was less than X, the destination of the CBW command corresponds to the embedded storage 56 or an external storage device of the disk extender 50, and the firmware 72 will handle this CBW command; the disk extender 50 then reads data from the embedded storage 56 or the external storage device and transmits the data to the master PC 62; go to step 210;

Step 208:

The LUN was equal to or greater than X, so the destination of the CBW command corresponds to one of the storage devices 66 of the slave PC 64; the disk extender 50 forwards the CBW command to the slave PC 64, and the slave PC 64 forwards the CBW command to the appropriate storage device 66 via the driver 76, ATAPI command router 74, and the I/O subsystem 78; the slave PC 64 then reads data from the storage device 66 and transmits it to the disk extender 50, and the disk extender 50 then transmits the data to the master PC 62;

Step 210:

The disk extender 50 sends a Command Status Wrapper (CSW) command to the master PC 62 (the CSW command is an ATAPI command specifying a status of the CBW command that was sent before) stating that the data read process has been completed; and

Step 212:End; the master PC 62 has read the requested data from either the embedded storage 56 in the disk extender 50 or from the storage device 66 in the slave PC 64.

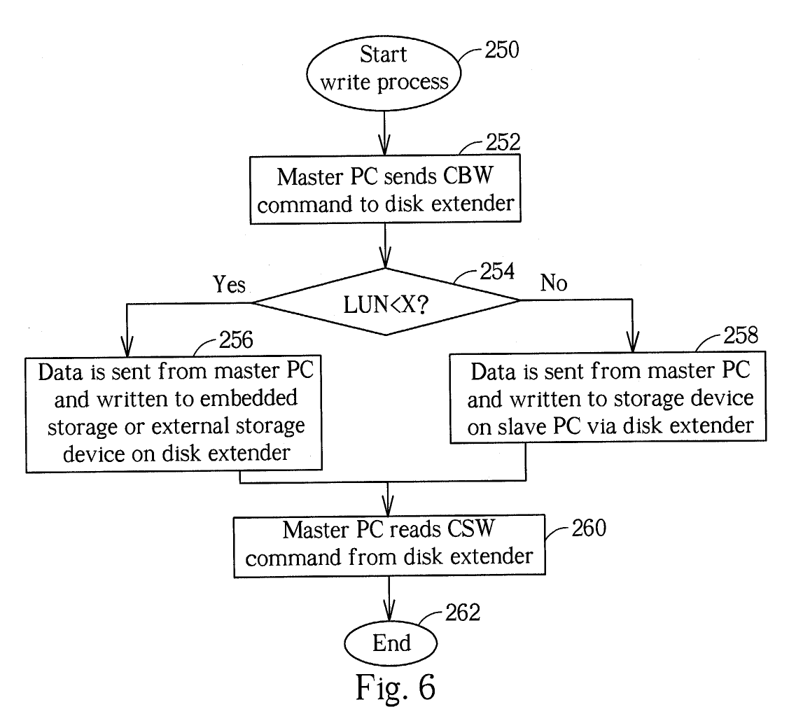

Please refer to FIG. 6. FIG. 6 is a flowchart illustrating the master PC 62 writing data through the use of the disk extender 50.

Step 250:

The write process is started to allow the master PC 62 to write data to either the embedded storage 56 in the disk extender 50 or to the storage device 66 in the slave PC 64;

Step 252:

The master PC 62 sends a Command Block Wrapper (CBW) command to the disk extender 50 (the CBW command is an ATAPI command specifying the LUN of the device to be written to and the amount of data to be written);

Step 254:

Determine if the LUN contained in the CBW command is less than X; if so, go to step 256; if not, go to step 258;

Step 256:

Since the LUN was less than X, the destination of the CBW command corresponds to the embedded storage 56 or the external storage device of the disk extender 50, and the firmware 72 will handle this CBW command; the disk extender 50 then receives data from the master PC 62 and writes the data to the embedded storage 56 or the external storage device; go to step 260;

Step 258:

The LUN was equal to or greater than X, so the destination of the CBW command corresponds to one of the storage devices 66 of the slave PC 64; the disk extender 50 forwards the CBW command to the slave PC 64, and the slave PC 64 forwards the CBW command to the appropriate storage device 66 via the driver 76, ATAPI command router 74, and the I/O subsystem 78; the disk extender 50 then receives data from the master PC 62 and transmits it to the slave PC 64, and the slave PC 64 writes the data to the storage device 66;

Step 260:

The disk extender 50 sends a Command Status Wrapper (CSW) command to the master PC 62 (the CSW command is an ATAPI command specifying a status of the CBW command that was sent before) stating that the data write process has been completed; and

Step 262:

End; the master PC 62 has written the requested data to either the embedded storage 56 in the disk extender 50 or to the storage device 66 in the slave PC 64.

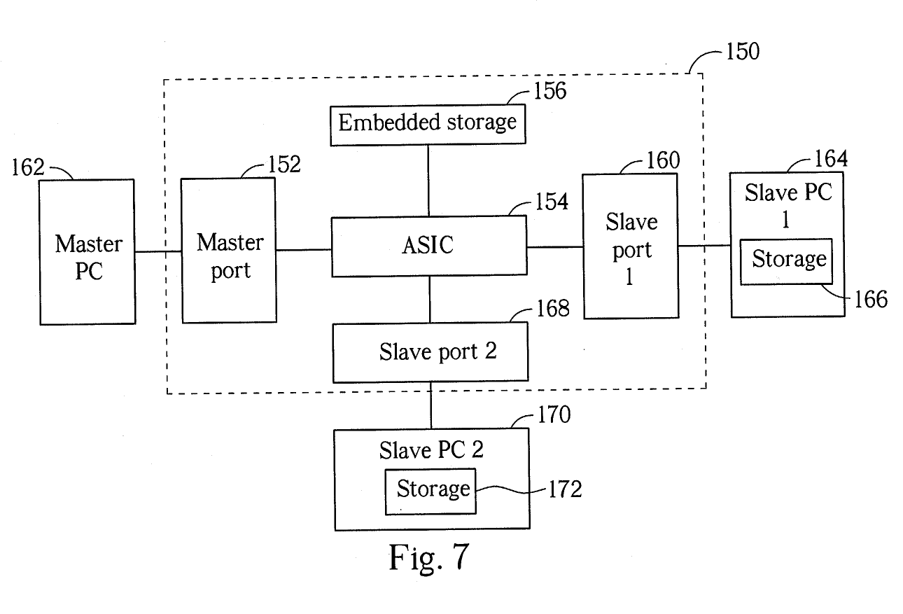

Please refer to FIG. 7. FIG. 7 is a block diagram of a disk extender 150 according to a second embodiment of the present invention. The disk extender 150 shown in FIG. 7 is identical to the disk extender 50 shown in FIG. 3 except a second slave port 168 is used instead of the expansion slot 58. By using a first slave port 160 in conjunction with the second slave port 168, the disk extender 150 is able to connect to storage 166 contained within a first slave PC 164 and storage 172 contained within a second slave PC 170, respectively.

A master port 152 of the disk extender 150 is preferably a male USB connector that connects to a female USB connector on a master PC 162, although a cable could also be used to connect the master port 152 to the master PC 162. The first slave port 160 and second slave port 168 preferably connect to the first slave PC 164 and the second slave PC 170 through cables, respectively. Although only two slave PCs 164, 170 are shown, the present invention is not restricted to this. Any number of slave PCs could be used with the present invention. In addition, a master PC could use the present invention disk extender to access any additional PCs networked to a slave PC.

The present invention disk extender can be made compatible with the USB or the USB On-The-Go (USB OTG) specification. Although USB is used for convenience of description, any serial bus could be used with the present invention, including the IEEE 1394 interface.

Compared to the prior art, the present invention combines functionality of a portable storage device with a network linker. This combination produces a disk extender that allows a master PC to connect to a slave PC such that the master PC can access data on both the disk extender and the slave PC, while at the same time preventing the slave PC from accessing data on either the disk extender or the master PC.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A portable storage device connecting to a master computer and a first slave computer through a serial bus interface, the portable storage device comprising:
a non-volatile memory for storing data in the portable storage device;
a first slave port for connecting the portable storage device to the first slave computer through the serial bus interface; and
a master port for connecting the portable storage device to the master computer through the serial bus interface;
wherein the master computer is capable of accessing data located on the portable storage device and storage apparatuses of the first slave computer and the first slave computer is not capable of accessing any data located on the portable storage device and the master computer.

2. The portable storage device of claim 1 further comprising a second slave port for connecting the portable storage device to a second slave computer through the serial bus interface, wherein the master computer is capable of accessing data located on the second slave computer and the second slave computer is not capable of accessing any data located on the portable storage device, the first slave computer, and the master computer.

3. The portable storage device of claim 1 further comprising an expansion port for connecting an external storage apparatus to the portable storage device, wherein the master computer is capable of accessing data located on the external storage apparatus and the first slave computer is not capable of accessing any data located on the external storage apparatus.

4. The portable storage device of claim 1 wherein the serial bus interface is a universal serial bus (USB) interface.

5. The portable storage device of claim 4 being compatible with the USB Mass Storage Class Bulk-Only Transport specification.

6. The portable storage device of claim 4 being compatible with the USB On-The-Go specification.

7. The portable storage device of claim 1 wherein the serial bus interface is an IEEE 1394 interface.

8. The portable storage device of claim 1 wherein the non-volatile memory is a flash memory.

9. A method of connecting a portable storage device to a master computer and a first slave computer through a serial bus interface, the method comprising:
providing a non-volatile memory in the portable storage device for storing data;
connecting the portable storage device to the first slave computer using the serial bus interface; and
connecting the portable storage device to the master computer through the serial bus interface, such that the master computer is capable of accessing data located on the portable storage device and storage apparatuses of the first slave computer and the first slave computer is not capable of accessing any data located on the portable storage device and the master computer.

10. The method of claim 9 further comprising connecting the portable storage device to a second slave computer through the serial bus interface, wherein the master computer is capable of accessing data located on the second slave computer and the second slave computer is not capable of accessing any data located on the portable storage device, the first slave computer, and the master computer.

11. The method of claim 9 further comprising connecting an external storage apparatus to the portable storage device, wherein the master computer is capable of accessing data located on the external storage apparatus and the first slave computer is not capable of accessing any data located on the external storage apparatus.

12. The method of claim 9 wherein the serial bus interface is a universal serial bus (USB) interface.

13. The method of claim 12 wherein the portable storage device is compatible with the USB Mass Storage Class Bulk-Only Transport specification.

14. The method of claim 12 wherein the portable storage device is compatible with the USB On-The-Go specification.

15. The method of claim 9 wherein the serial bus interface is an IEEE 1394 interface.

16. The method of claim 9 wherein the non-volatile memory is a flash memory.
